(19) United States
(12) Patent Application Publication
(10) Pub. No.: US 2003/0138599 A1
(43) Pub. Date: Jul. 24, 2003

(54) Thermally transferable image protective sheet, method for protective layer formation, and record produced by said method

(75) Inventor: Yoshinori Kamikubo, Shinjuku-ku (JP)

Correspondence Address: PARKHURST & WENDEL, L.L.P., 1421 PRINCE STREET, SUITE 210, ALEXANDRIA, VA, 22314-2805, US

(73) Assignee: Dai Nippon Printing Co., Ltd., Shinjuku-ku (JP)

(21) Appl. No.: 10/341,562

(22) Filed: Jan. 14, 2003

(30) Foreign Application Priority Data
Jan. 17, 2002 (JP) 2002-8887

(51) Int. Cl. B32B 1/00; D06N 7/04

(52) U.S. Cl. 428/141; 428/195.1

(57) ABSTRACT

The present invention provides a thermally transferable image protective sheet, that can be thermally transferred to form a protective layer which can protect an image in a record immediately produced by a nonsilver photographic color hard copy recording method, can impart lightfastness and other properties to the resultant record and, in the case of records for outdoor applications or the like, can prevent dazzle caused by the reflection of light at the time of viewing of the image, a method for protective layer formation, and a record produced by the method for protective layer formation. The thermally transferable image protective sheet comprises a support and a thermally transferable resin layer having a single-layer or multilayer structure stacked on the support so as to be separable from the surface of the support. In use, thermally transferable resin layer is thermally transferred on an image in a print so as to cover at least the printed portion in the print followed by the separation of the support. The thermally transferable image protective sheet has been constructed so that the specular glossiness of the surface of the thermally transferable resin layer after transfer in the print is regulatable to less than 65% as measured at 60 degrees according to JIS Z 8741, or the surface roughness Ra of the thermally transferable resin layer after transfer in the print is regulatable to not less than 0.130.

### TECHNICAL FIELD

The present invention relates to a thermally transferable image protective sheet, that can be thermally transferred to form a protective layer which can protect an image in a record produced by a nonsilver photographic color hard copy recording method such as an electrophotographic recording method, an ink jet recording method, or a thermal transfer recording method, can impart lightfastness and other properties to the record, can render the surface of the image in the record matte, can prevent dazzle caused by the reflection of light at the time of viewing of the image, can increase the angle of visibility, and can realize easy-to-see display contents, a method for protective layer formation, and a record produced by the method.

### BACKGROUND ART

By virtue of the advance of digital cameras and color hard copy technology in recent years, prints having full-color images formed thereon by a nonsilver photographic method, such as an electrophotographic recording method, an ink jet recording method, or a thermal transfer recording method, could have become immediately prepared in situ as the need arises, as opposed to a conventional method wherein a person asks a processing laboratory for development and receives prints later from the processing laboratory.

In these color copy prints, however, images blur upon contact with water, chemicals or the like located close thereto. Further, upon rubbing against hard objects, images are disadvantageously separated or smeared.

For example, in the electrophotographic recording method, a toner image is transferred onto an image receiving object, the toner is melted by a hot roll, and the melted toner is self-cooled to adhere and fix the cooled toner onto the image receiving object. The records thus obtained, however, are unsatisfactory in lightfastness of images yielded by yellow toner.

Further, records produced by the ink jet recording method are disadvantageous in that images yielded by ink jet recording inks have low lightfastness and low ozonefastness.

On the other hand, Japanese Patent Laid-Open No. 224779/1983 proposes a recording apparatus wherein a laminate material with a hot-melt adhesive is heated together with a recorded material to apply the laminate material to the recorded material.

Further, Japanese Patent Laid-Open No. 315641/1998 proposes a method wherein, in order to protect an image in a print produced by a transfer recording method such as a thermal dye sublimation transfer method or an ink jet recording method, a protective layer is thermally transferred, onto the print, using a protective layer transfer sheet comprising a substrate and a protective layer provided separably on the substrate.

The prior art technique, wherein a plastic film, such as a high-gloss PET film, is laminated on the surface of the image in the record, and the prior art technique, wherein a protective layer is thermally transferred, onto the surface of the image in the record, using the conventional protective layer transfer sheet, are disadvantageous in that the surface of the image is glary and, at the time of viewing of the image, the dazzle of reflected light is high. Therefore, the above prior art techniques are unsuitable for prints for outdoor applications or the like where the angle of visibility should be large.

When a gloss-free matte texture is desired, the prior art technique, wherein an image is formed on an image receiving paper, of which the surface has a matte texture, and a plastic film such as a high-gloss PET film is laminated on the surface of the image in the record, and the prior art technique, wherein a protective layer is thermally transferred, on the surface of the image in the record, using the protective layer transfer sheet, are disadvantageous in that the surface of the print is glossy and, thus, the matte texture of the image receiving paper is often lost.

### DISCLOSURE OF THE INVENTION

In view of the above problems of the prior art, the present invention has been made, and it is an object of the present invention to provide a thermally transferable image protective sheet, that can be thermally transferred to form a protective layer which can protect an image in a record immediately produced by a nonsilver photographic color hard copy recording method, can impart lightfastness and other properties to the resultant record and, in the case of records for outdoor applications or the like, can prevent dazzle caused by the reflection of light at the time of viewing of the image, a method for protective layer formation, and a record produced by the method for protective layer formation.

According to one aspect of the present invention, there is provided a thermally transferable image protective sheet comprising: a support; and a thermally transferable resin layer having a single-layer or multilayer structure stacked on the support so as to be separable from the surface of the support, the thermally transferable image protective sheet having been constructed so that the thermally transferable resin layer is thermally transferred on an image in a print so as to cover at least the printed portion in the print followed by the separation of the support and the specular glossiness of the surface of the thermally transferable resin layer after transfer in the print is regulatable to less than 65% as measured at 60 degrees according to JIS Z 8741.

According to another aspect of the present invention, there is provided a thermally transferable image protective sheet comprising: a support; and a thermally transferable resin layer having a single-layer or multilayer structure stacked on the support so as to be separable from the surface of the support, the thermally transferable image protective sheet having been constructed so that the thermally transferable resin layer has been thermally transferred on an image in a print so as to cover at least the printed portion in the print followed by the separation of the support and the surface roughness Ra of the thermally transferable resin layer after transfer in the print is regulatable to not less than 0.130.

According to still another aspect of the present invention, there is provided a thermally transferable image protective sheet comprising: a support; and a thermally transferable resin layer having a single-layer or multilayer structure stacked on the support so as to be separable from the surface of the support, the thermally transferable image protective sheet having been constructed so that the thermally transferable resin layer is thermally transferred on an image in a print so as to cover at least the printed portion in the print followed by the separation of the support and the specular glossiness of the surface of the support on its thermally transferable resin layer side is less than 65% as measured at 60 degrees according to JIS Z 8741.

According to a further aspect of the present invention, there is provided a thermally transferable image protective sheet comprising: a support; and a thermally transferable resin layer having a single-layer or multilayer structure stacked on the support so as to be separable from the surface of the support, the thermally transferable image protective sheet having been constructed so that the thermally transferable resin layer is thermally transferred on an image in a print so as to cover at least the printed portion in the print followed by the separation of the support and the surface roughness Ra of the support on its thermally transferable resin layer side is not less than 0.100.

In the present invention, preferably, a filler has been incorporated in the support to roughen the surface of the support on its image protective layer side.

Preferably, the image in the print has been formed by an electrophotographic recording method, an ink jet recording method, or a thermal transfer recording method.

According to another aspect of the present invention, there is provided a method for protective layer formation, comprising the steps of: providing any one of the above thermally transferable image protective sheets and a print; putting the thermally transferable image protective sheet and the print on top of each other so that the thermally transferable resin layer is brought into contact with the image face of the print, and thermally transferring the thermally transferable resin layer onto the image in the print so as to cover at least the printed portion in the print; and then separating the support to form a protective layer on the image in the print.

According to a further aspect of the present invention, there is provided a record comprising a protective layer provided on an image in a print, said protective layer having been provided by thermally transferring a thermally transferable resin layer by the above method for protective layer formation.

The thermally transferable image protective sheet of the present invention comprises a support and a thermally transferable resin layer having a single-layer or multilayer structure stacked on the support so as to be separable from the surface of the support. The thermally transferable resin layer is thermally transferred on an image in a print so as to cover at least the printed portion in the print followed by the separation of the support. In this case, the specular glossiness of the surface of the thermally transferable resin layer after transfer in the print is less than 65% as measured at 60 degrees according to JIS Z 8741, or the surface roughness Ra of the thermally transferable resin layer after transfer in the print is not less than 0.130, or the specular glossiness of the surface of the support on its thermally transferable resin layer side is less than 65% as measured at 60 degrees according to JIS Z 8741, or the surface roughness Ra of the support on its thermally transferable resin layer side is not less than 0.100. By virtue of the above construction, in a print (a record) covered with the thermally transferable resin layer after transfer from the thermally transferable image protective sheet, the image is protected, possesses excellent fastness or resistance properties such as excellent lightfastness, and, in the case of records for outdoor applications or the like, is free from dazzle caused by the reflection of light at the time of viewing of the image.

### BRIEF DESCRIPTION OF THE DRAWINGS

FIG. 1 is a schematic cross-sectional view showing one embodiment of the thermally transferable image protective sheet according to the present invention;

FIG. 2 is a schematic cross-sectional view showing another embodiment of the thermally transferable image protective sheet according to the present invention; and

FIG. 3 is an explanatory view showing one embodiment of the method for protective layer formation according to the present invention.

### BEST MODE FOR CARRYING OUT THE INVENTION

The thermally transferable image protective sheet, the method for protective layer formation, and the record produced by the method for protective layer formation according to the present invention will be explained in conjunction with the accompanying drawings.

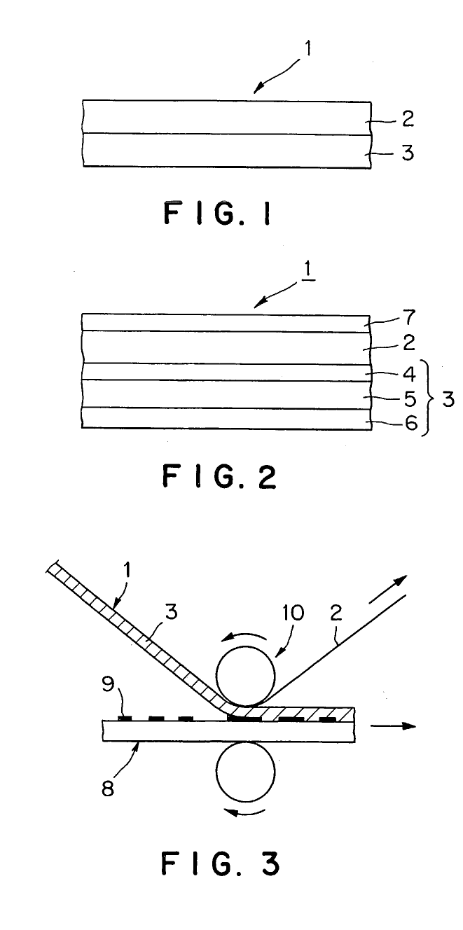

FIG. 1 is a schematic cross-sectional view showing one embodiment of the thermally transferable image protective sheet 1 according to the present invention. In the thermally transferable image protective sheet 1, a thermally transferable resin layer 3 is provided directly on a support 2. Upon heating, the thermally transferable resin layer 3 can be separated from the support 2. In this case, the thermally transferable resin layer 3 has a single-layer structure.

FIG. 2 is a schematic cross-sectional view showing another embodiment of the thermally transferable image protective sheet 1 according to the present invention. In the thermally transferable image protective sheet 1, a peel layer 4, a main protective layer 5, and an adhesive layer 6 are provided in that order on a support 2. In this case, upon heating of the thermally transferable image protective sheet 1, three layers of the peel layer 4, the main protective layer 5, and the adhesive layer 6 are separated from the support 2. That is, in this embodiment, the thermally transferable resin layer 3 has a three-layer structure. By virtue of the provision of the peel layer 4, upon heating of the thermally transferable image protective sheet 1, the thermally transferable resin layer 3 can be easily separated from the support 2. Further, the thermally transferable resin layer 3 has the adhesive layer 6 which constitutes the outermost surface of the thermally transferable image protective sheet 1. The provision of this adhesive layer 6 can enhance the transferability of the thermally transferable resin layer 3 onto a print and the adhesion between the thermally transferable resin layer 3 and the print. A heat-resistant slip layer 7 may be provided on the other side of the support 2 to avoid adverse effects, for example, sticking to heating means, such as a thermal head, or cockling.

FIG. 3 is an explanatory view showing one embodiment of the method for protective layer formation according to the present invention. In this embodiment, the method for protective layer formation comprises the following steps. A print 8 and a thermally transferable image protective sheet 1 are first provided. The print 8 has an image 9 formed by any one of an electrophotographic recording method, an ink jet recording method, and a thermal transfer recording method. The thermally transferable image protective sheet 1 includes a support 2 and a thermally transferable resin layer 3 provided separably on the support 2. The print 8 and the thermally transferable image protective sheet 1 are put on top of each other so that the image 9 in the print 8 faces the thermally transferable resin layer 3 in the thermally transferable image protective sheet 1. The thermally transferable resin layer 3 is thermally transferred onto the image 9 in the print 8 by a heat roll as thermal transfer means 10. Thereafter, the support 2 is separated and removed.

(Thermally Transferable Image Protective Sheet)

The thermally transferable image protective sheet 1 according to the present invention comprises a support and a thermally transferable resin layer having a single-layer or multilayer structure stacked on one side of the support. In the thermally transferable image protective sheet, a thermally transferable resin layer having a single-layer structure may be provided on the support. Alternatively, a thermally transferable resin layer having a multilayer structure separable from the support, for example, a two-layer or three-layer structure of main protective layer (peel layer)/adhesive layer, main protective layer (peel layer)/adhesive layer/antistatic layer, peel layer/main protective layer/adhesive layer or the like, may be provided on the support.

Each layer constituting the thermally transferable image protective sheet will be described.

(Support)

In the thermally transferable image protective sheet according to the present invention, any conventional support may be used as the support 2 so far as the support has a certain level of heat resistance and a certain level of strength and the specular glossiness of the surface of the support on its thermally transferable resin layer side is less than 65% as measured at 60 degrees according to JIS Z 8741, or the surface roughness Ra of the support on its thermally transferable resin layer side is not less than 0.100. Examples of the support usable herein include tissue papers, such as glassine paper, capacitor paper, and paraffin paper; plastics, for example, polyesters, such as polyethylene terephthalate and polyethylene naphthalate, polypropylene, cellophane, polycarbonate, cellulose acetate, polyethylene, polyvinyl chloride, polystyrene, nylon, polyimide, polyvinylidene chloride, and ionomers; and composite sheets comprising combinations of the plastics and the papers. Particularly preferred are films of polyesters such as polyethylene terephthalate and polyethylene naphthalate.

The surface of the plastic film can be regulated so as to have a specular glossiness of less than 65% as measured at 60 degrees according to JIS Z 8741 or a surface roughness Ra of not less than 0.100, for example, by a sandblasting method wherein alumina abrasive grains are blasted against the surface of the plastic film to roughen the smooth surface of the plastic film, or by a method wherein a mixture comprising a plastic and, mixed into the plastic, an inorganic filler, such as calcium carbonate, titanium oxide, barium sulfate, or silicon oxide, or an organic filler, such as acrylic acids or styrene, is provided as a raw material and a film is formed from the mixture by a conventional film formation method comprising melting and extrusion in combination with uniaxial stretching or biaxial stretching.

The support produced by the sandblasting method is not very advantageous due to the presence of burrs on its surface. The presence of burrs increases the peel force necessary for the separation of the support. Therefore, when an image receiving sheet (a print) used has low cohesive force, the support cannot be separated from the thermally transferable resin layer after the transfer. This disadvantageously sometimes results in cohesive failure in a receptive layer provided in the image receiving sheet.

On the other hand, the support produced by incorporating the filler in the plastic material by milling is advantageous in that, since the peel force between the support and the thermally transferable resin layer after the transfer is relatively small, even when an image receiving sheet (a print) having low cohesive force is used, the above-described cohesive failure in the receptive layer provided in the image receiving sheet can be avoided.

The thickness of the support may properly vary depending upon the material for the support so that the support has proper strength, heat resistance and other properties. Preferably, however, the thickness of the support is about 9 to 100 μm. When the thickness of the support is less than 9 μm, in passing the assembly of the thermally transferable image protective sheet and the print through a heating device such as a laminator, the thermally transferable image protective sheet is disadvantageously likely to undergo cockling. On the other hand, when the thickness of the support exceeds 100 μm, heat necessary for the transfer of the thermally transferable resin layer is not likely to be conveyed to the outermost surface of the thermally transferable resin layer. This disadvantageously makes it difficult to transfer the thermally transferable resin layer onto the print.

The surface of the support on its side remote from the thermally transferable resin layer may have been subjected to corona treatment or the like.

(Heat-Resistant Slip Layer)

In the thermally transferable image protective sheet used in the present invention, a heat-resistant slip layer 7 may be optionally provided on the support in its side remote from the thermally transferable resin layer from the viewpoint of avoiding adverse effects, such as sticking or cockling caused by heat from the thermal head, the heat roll or the like as heat transfer means 10.

Any conventional resin may be used as the resin for the formation of the heat-resistant slip layer 7, and examples thereof include polyvinylbutyral resins, polyvinylacetoacetal resins, polyester resins, vinyl chloride-vinyl acetate copolymers, polyether resins, polybutadiene resins, styrene-butadiene copolymers, acrylic polyols, polyurethane acrylates, polyester acrylates, polyether acrylates, epoxy acrylates, urethane or epoxy prepolymers, nitrocellulose resins, cellulose nitrate resins, cellulose acetopropionate resins, cellulose acetate butyrate resins, cellulose acetate hydrogenphthalate resins, cellulose acetate resins, aromatic polyamide resins, polyimide resins, polycarbonate resins, and chlorinated polyolefin resins.

Slip property-imparting agents added to or coated onto the heat-resistant slip layer formed of the above resin include phosphoric esters, silicone oils, graphite powders, silicone graft polymers, fluoro graft polymers, acrylic silicone graft polymers, acrylsiloxanes, arylsiloxanes, and other silicone polymers. Preferably, the heat-resistant slip layer is formed of apolyol, for example, a polyalcohol polymer compound, a polyisocyanate compound, or a phosphoric ester compound. Further, the addition of a filler is more preferred.

The heat-resistant slip layer may be formed by dissolving or dispersing the above resin, slip property-imparting agent, and filler in a suitable solvent to prepare an ink for a heat-resistant slip layer, coating the ink on the backside of the substrate sheet, for example, by gravure printing, screen printing, reverse coating using a gravure plate or other formation means, and drying the coating.

(Peel Layer)

The thermally transferable image protective sheet according to the present invention comprises a support and a thermally transferable resin layer having a single-layer or multilayer structure stacked separably on the support. In order to easily separate the thermally transferable resin layer 3 from the support upon heating, the thermally transferable resin layer 3 may have a construction such that a peel layer 4 is provided as a layer in contact with the support and a main protective layer, an adhesive layer and the like are further provided on the peel layer 4.

Upon heating, this peel layer is separated from the support and is transferred onto a print in an object to serve as the outermost layer in a protective layer for the print. Accordingly, upon heating, the peel layer on its surface in contact with the support is separated and serves as the surface of the protective layer for the print, and the specular glossiness of the surface of the protective layer as measured at 60 degrees according to JIS Z 8741 is less than 65%.

Specific examples of binders usable in the peel layer include cellulosic resins, melamine resins, polyester resins, polyamide resins, polyolef in resins, acrylic resins, styrene resins, ethylene-vinyl acetate copolymers, styrene-butadiene rubbers and other thermoplastic elastomers. Binders having a relatively low softening point, for example, a softening point of 50 to 80° C., commonly used as heat-sensitive adhesives in the art are particularly preferred.

The peel layer may be formed by coating a coating liquid for a peel layer by a conventional method, such as gravure direct coating, gravure reverse coating, knife coating, air coating, or roll coating, to a thickness on a dry basis of about 0.05 to 5 g/m². When the thickness of the coating on a dry basis is less than 0.05 g/m², the adhesion between the support and the thermally transferable resin layer is improved and, consequently, good separation effect cannot be attained. On the other hand, when the thickness of the coating on a dry basis exceeds 5 g/m², the sensitivity in transfer at the time of printing is disadvantageously lowered.

(Main Protective Layer)

The main protective layer 5 constituting the thermally transferable resin layer having a single-layer or multilayer structure provided on the support in the thermally transferable image protective sheet used in the present invention may be formed of various conventional resins known as resins for a protective layer. Examples of resins for a protective layer usable herein include thermoplastic resins, for example, polyester resins, polystyrene resins, acrylic resins, polyurethaneresins, acrylatedurethaneresins, epoxy resins, phenoxy resins, silicone-modified products of these resins, mixtures of these resins, ionizing radiation-curable resins, and ultraviolet screening resins. In addition, if necessary, ultraviolet absorbers, organic fillers and/or inorganic fillers may be properly added.

A main protective layer containing an ionizing radiation-cured resin is particularly excellent in plasticizer resistance and scratch resistance. The ionizing radiation-curable resin usable for this purpose may be any conventional one. For example, a resin formed by crosslinking and curing a radically polymerizable polymer or oligomer through ionizing radiation irradiation and, if necessary, adding a photopolymerization initiator thereto, and then performing polymerization crosslinking by applying an electron beam or ultraviolet light may be used. The ionizing radiation-cured resin may also be added to the peel layer and the adhesive layer in the thermally transferable image protective sheet.

A main protective layer containing an ultraviolet screening resin or an ultraviolet absorber mainly functions to impart lightfastness to prints. An example of the ultraviolet screening resin is a resin formed by reacting a reactive ultraviolet absorber with a thermoplastic resin or the above-described ionizing radiation-curable resin to bond the ultraviolet absorber to the resin. More specifically, the ultraviolet screening resin may be, for example, a resin produced by introducing a reactive group, such as an addition-polymerizable double bond (for example, a vinyl, acryloyl, or methacryloyl group) or an alcoholic hydroxyl, amino, carboxyl, epoxy, or isocyanate group into a conventional nonreactive organic ultraviolet absorber, for example, a salicylate, phenyl acrylate, benzophenone, benzotriazole, cumarin, triazine, or nickel chelate nonreactive organic ultraviolet absorber.

The ultraviolet absorber may be a conventional nonreactive organic ultraviolet absorber, and examples thereof include salicylate, phenyl acrylate, benzophenone, benzotriazole, cumarin, triazine, and nickel chelate nonreactive organic ultraviolet absorbers.

The ultraviolet screening resin and the ultraviolet absorber may also be added to the peel layer and the adhesive layer in the thermally transferable image protective sheet.

The amount of the ultraviolet screening resin and the ultraviolet absorber added is 1 to 30% by weight, preferably about 5 to 20% by weight, based on the binder resin.

Specific examples of organic fillers and/or inorganic fillers include, but are not particularly limited to, polyethylenewax, bisamide, nylon, acrylic resin, crosslinked polystyrene, silicone resin, silicone rubber, talc, calcium carbonate, titanium oxide, and finely divided silica such as microsilica and colloidal silica. Preferably, the filler has good slipperiness and has a particle diameter of not more than 10 μm, more preferably in the range of 0.1 to 3 μm. Preferably, the amount of the filler added is in the range of 0 to 100 parts by weight based on 100 parts by weight of the above resin component and, at the same time, is such that the transferred main protective layer can be kept transparent.

The main protective layer may be formed by dissolving or dispersing the above resin for a protective layer and optional additives, such as an ultraviolet absorber, an organic filler and/or an inorganic filler, in a suitable solvent to prepare an ink for a main protective layer, coating the ink onto the above support by formation means, such as gravure printing, screen printing, or reverse coating using a gravure plate, and drying the coating.

In this case, the coating is carried out so that the coverage of the whole layer to be transferred (thermally transferable resin layer) in the thermally transferable image protective sheet used in the present invention is about 2 to 30 g/m², preferably 3 to 20 g/m², on a dry basis.

When the main protective layer functions also as a peel layer and/or an adhesive layer, the thermally transferable resin layer may be constituted by a single layer alone, i.e., the main protective layer alone, or alternatively the layer construction of the thermally transferable resin layer may be properly varied.

(Adhesive Layer)

In the thermally transferable image protective sheet used in the present invention, an adhesive layer 6 may be provided on the surface of the main protective layer or the peel layer from the viewpoints of improving the transferability of the thermally transferable resin layer onto the print as an object and, at the same time, improving the adhesion of the thermally transferable resin layer after transfer to the print as the object. The adhesive layer may be formed of any conventional pressure-sensitive adhesive or heat-sensitive adhesive. The adhesive layer is preferably formed of a thermoplastic resin having a glass transition temperature (Tg) of 40 to 80° C. For example, the selection of a resin having a suitable glass transition temperature from resins having good heat adhesion, for example, polyester resins, vinyl chloride-vinyl acetate copolymer resins, acrylic resins, ultraviolet screening resins, butyral resins, epoxy resins, polyamide resins, and vinyl chloride resins, is preferred.

Ultraviolet screening resins, which may be added to the adhesive layer, may be the same as those described above in connection with the main protective layer.

The adhesive layer may be formed by coating a coating liquid containing the resin for constituting the adhesive layer and optional additives, such as an ultraviolet absorber and an inorganic or organic filler, and drying the coating to form an adhesive layer preferably having a thickness of about 0.5 to 10 g/m² on a dry basis. When the thickness of the adhesive layer is below the lower limit of the above-defined thickness range, the adhesion between the print and the thermally transferable resin layer is so low that, at the time of printing, a failure of the thermally transferable resin layer to be transferred onto the print is likely to occur. On the other hand, when the thickness of the adhesive layer is above the upper limit of the above-defined thickness range, the sensitivity in transfer at the time of the thermal transfer of the protective layer is lowered and, consequently, the formation of a uniform protective layer by the thermal transfer is difficult.

The above-described layers constituting the thermally transferable resin layer provided separably on the support, such as the peel layer, the main protective layer, and the adhesive layer, should have transparency on a level high enough not to hinder the viewing of the underlying image after the transfer of the thermally transferable resin layer onto the print.

(Print)

The print 8 used in the present invention is one which has been output by any nonsilver photographic color hard copy recording method selected from an electrophotographic recording method, an ink jet recording method, and a thermal transfer recording method. In this case, an image may be formed directly on a substrate. Alternatively, if necessary, a receptive layer suitable for the recording method used may be provided on the substrate so that the recording material can be easily received and fixed.

Substrates for the print usable herein include, for example, synthetic papers (such as polyolefin and polystyrene papers), wood-free papers, art papers, coated papers, cast coated papers, wallpapers, backing papers, papers impregnated with synthetic resin or emulsion, papers impregnated with synthetic rubber latex, papers with synthetic resin being internally added thereto, cellulosic fiber papers, such as paperboards, various plastic films or sheets, such as films or sheets of polyolefin, polystyrene, polycarbonate, polyethylene terephthalate, polyvinyl chloride, and polymethacrylate. Further, additional examples of films or sheets usable herein include, but are not particularly limited to, white opaque films prepared by adding a white pigment or a filler to the synthetic resin and forming a film from the mixture, and films with microvoids in the interior of the substrate. Further, a laminate of any combination of the above substrates may also be used.

The thickness of these substrates may be any one, and, for example, is generally about 10 to 300 μm.

An electrophotographic recording method is one of the recording methods usable in the formation of images in the above prints. The principle of this recording method is as follows. When a photoreceptor passes through an electrifier, ions generated by corona discharge are evenly electrified on the surface of the photoreceptor. The surface of the photoreceptor is imagewise exposed in an exposure section. Electrified charges in areas exposed to light are removed by a photo-conducting phenomenon to form a latent image using charges in non-exposed areas. Next, in a development section, a charged toner is electrostatically deposited onto the latent image to form a visible image which is then transferred onto a print in a transfer section. The transferred image is then fixed onto the print by heat and pressure in a fixation section.

In the formation of a full-color image, toners of four colors, i.e., yellow, magenta, cyan, and black toners, are provided, and the above-described process is repeated for each of the toners.

An ink jet recording method may be used as one of the recording methods for the formation of images on prints. According to this method, ink droplets are ejected and deposited directly onto a recording medium to form characters or images. For example, in anon-demand-type ink jet recording method, droplets of ink are formed in response to image signals to perform recording. The on-demand-type ink jet recording method is classified, for example, into an electromechanical conversion type wherein a piezoelectric element is energized to change the volume of an ink chamber to eject the ink through nozzles, and an electrothermal conversion method wherein a heating element is buried in nozzles and is energized to instantaneously heat and boil the ink and consequently to form bubbles in the ink, which bubbles cause a rapid volume change to eject the ink through the nozzles. In the formation of a full-color image, inks of four colors of yellow, magenta, cyan, and black are provided, and the above-described process is repeated for each ink.

Further, a thermal transfer recording method may be mentioned as one of the recording methods for the formation of images on prints. According to this method in recording, heat energy controlled by image signals is generated by a thermal head and is used as an activating energy for recording materials such as inks. More specifically, an ink ribbon is put on top of recording paper, and the laminate is passed through between a thermal head and a platen under a suitable level of pressure. In this case, the recording material is activated by the thermal head heated by energization and is transferred onto the recording paper with the aid of the pressure of the platen. This transfer recording method may be classified into a thermal ink transfer type and a thermal dye sublimation transfer type, and any of these types may be used in the formation of images on prints according to the present invention.

An image may be formed on recording paper by any one of the above-described nonsilver photographic color hard copy recording methods, i.e., electrophotographic recording, ink jet recording, and thermal transfer recording methods. Alternatively, a combination of a plurality of the above recording methods may be used. For example, a method may be used wherein, in a halftone image portion, recording is carried out by the electrophotographic recording method while, in a character portion, recording is carried out by the thermal ink transfer recording method.

The receptive layer may be formed by adding optional additives to a resin suitable for a recording method used, dissolving or dispersing the mixture in a suitable solvent to prepare a coating liquid, applying the coating liquid onto a substrate by conventional printing means, such as gravure printing or silk screen printing, or conventional coating means, such as gravure coating, to a thickness of about 0.5 to 10 μm on a dry basis.

(Method for Protective Layer Formation)

The method for protective layer formation according to the present invention includes the steps of: providing the above thermally transferable image protective sheet and the above print; putting the thermally transferable image protective sheet and the print on top of each other so that the thermally transferable resin layer is brought into contact with the image face of the print, and thermally transferring the thermally transferable resin layer onto the image in the print so as to cover at least the printed portion in the print; and then separating the support to form a protective layer on the image in the print. In the method for protective layer formation, the thermally transferable resin layer is thermally transferred as a protective layer, from a thermally transferable image protective sheet comprising a thermally transferable resin layer provided separably on a support, onto an image in a print formed by a nonsilver photographic color hard copy recording method. In this case, means usable for the thermal transfer of the thermally transferable resin layer as the protective layer includes: heating by a thermal head in such a state that a print and a thermally transferable image protective sheet are sandwiched between a thermal head and a platen; a heat roll method as shown in FIG. 3 (which is mainly used in commercially available laminators and uses hot pressing by means of a pair of heat rolls); sandwiching of a print and a thermally transferable image protective sheet between a heated flat plate and a flat plate; and sandwiching of a print and a thermally transferable image protective sheet between a heated flat plate and a roll followed by hot pressing. Further, thermal transfer means using heating by laser irradiation is also applicable.

In the method for protective layer formation according to the present invention, means for forming an image in a print by the nonsilver photographic color hard copy recording method, such as an electrophotographic recording method, an ink jet recording method, or a thermal transfer recording method, and means for the thermal transfer of a protective layer on an image in a print using a thermally transferable image protective sheet comprising a thermally transferable resin layer separably provided on a support are carried out in an in-line or offline manner which may be freely specified. When the above means is carried out in an in-line manner, the image forming means and the protective layer thermal transfer means may be carried out in an identical apparatus, or alternatively, separate apparatuses may be connected to each other and, in this state, may be used for carrying out these means.

The method for protective layer formation according to the present invention is advantageous in that, after the formation of an image in a print by an electrophotographic recording method, a protective layer can be formed on the toner image in the print by using means for the thermal transfer of a protective layer. Therefore, fastness or resistance properties, such as lightfastness, of images of toners of yellow, magenta, cyan and the like can be improved.

Prints yielded by an ink jet recording method, when allowed to stand in the air, are likely to undergo a change in hue under the influence of ozone, oxygen or the like. The protective layer formed by the thermal transfer of the thermally transferable resin layer according to the present invention can function also as a gas barrier and thus can avoid this unfavorable phenomenon and can improve fastness or resistance properties of the images in the prints.

In the present invention, the specular glossiness of the surface of the thermally transferable resin layer after transfer in the print, or the specular glossiness of the surface of the support on its thermally transferable resin layer side is less than 65% as measured at 60 degrees according to JIS Z 8741. A specular glossiness of 20 to 30% is most preferred from the practical point of view, because, at the time of viewing of the image, dazzle caused by the reflection of light can be prevented. When the specular glossiness is not less than 65%, the surface of the object, on which the protective layer has been formed by the thermal transfer, is glary. Therefore, in this case, at the time of viewing of the image, the level of dazzle caused by the reflection of light is disadvantageously very high. On the other hand, when the specular glossiness is excessively low, at the time of the thermal transfer, the separation of the thermally transferable resin layer from the support is difficult. For this reason, the specular glossiness should be not less than 10%.

The surface roughness of the thermally transferable resin layer after transfer in the print, or the surface roughness of the support on its thermally transferable resin layer side is not less than 0.100. A surface roughness of 0.150 to 0.700 is most preferred from the practical point of view, because, at the time of viewing of the image, dazzle caused by the reflection of light can be prevented. When the surface roughness is less than 0.100, the surface of the object, on which the protective layer has been formed by the thermal transfer, is glary. Therefore, in this case, at the time of viewing of the image, the level of dazzle caused by the reflection of light is disadvantageously very high. On the other hand, when the surface roughness is excessively large, at the time of the thermal transfer, the separation of the thermally transferable resin layer from the support is difficult.

### EXAMPLES

The following examples further illustrate the present invention. In the following description, “parts” or “%” is by weight unless otherwise specified.

### Examples 1 to 3 and Comparative Example 1

Thermally transferable image protective sheets of Examples 1 to 3 and Comparative Example 1 were prepared under the following conditions.

Polyethylene terephthalate films shown in Table 1 were provided as supports. A coating liquid for a peel layer having the following composition was gravure coated onto the supports at a coverage of 1.5 g/m² on a dry basis. In this case, the supports were not subjected to primer treatment or the like, and the coating liquid was coated directly onto the supports. Each coating was then dried at 110° C. for 1 min to form a peel layer.

<Coating liquid for peel layer>

| | | |
|---|---|---|
| BR-87 (acrylic resin, manufactured | 100 | parts |
| by Mitsubishi Rayon Co., Ltd.) | | |
| RV 220 (polyester resin, manufactured | 0.5 | part |
| by Toyobo Co., Ltd.) | | |
| Methyl ethyl ketone | 200 | parts |
| Toluene | 200 | parts |

Next, a coating liquid for an adhesive layer having the following composition was gravure coated on each peel layer at a coverage of 3.5 g/m² on a dry basis, and the coating was then dried at 110° C. for 1 min to form an adhesive layer. Thus, thermally transferable image protective sheets of Examples 1 to 3 and Comparative Example 1 were prepared.

<Coating liquid for adhesive layer>

| | | |
|---|---|---|
| RV 700 (polyester resin, manufactured | 100 | parts |
| by Toyobo Co., Ltd.) | | |
| TINUVIN 900 (a benzotriazole ultraviolet | 10 | parts |
| absorber, manufactured by Ciba-Geigy) | | |
| Methyl ethyl ketone | 200 | parts |
| Toluene | 200 | parts |

TABLE 1

| | | | Specular | |
|---|---|---|---|---|
| | | | glossiness | |
| | | | of surface | Surface |
| | | Production | of support | roughness |
| | | method | as measured | Ra of |
| | Support | of support | at 60 degrees | support |
| Ex. 1 | Lumirror 26-X42, | Incorporation | 17.5% | 0.532 |
| | manufactured by | of filler | | |
| | Toray Industries, | | | |
| | Inc. | | | |
| Ex. 2 | Lumirror 26-X45, | Incorporation | 63.7% | 0.263 |
| | manufactured by | of filler | | |
| | Toray Industries, | | | |
| | Inc. | | | |
| Ex. 3 | Lumimat #200 | Sandblasting | 7.0% | 0.582 |
| | Tress, manufactured | | | |
| | by Toray Industries, | | | |
| | Inc. | | | |
| Comp. | Lumirror T-70A, | — | 143% | 0.089 |
| Ex. 1 | manufactured by | | | |
| | Toray Industries, | | | |
| | Inc. | | | |

<Transfer of Thermally Transferable Image Protective Sheet onto Image Receiving Sheet>

Each of the thermally transferable image protective sheet prepared above was put on top of an ink jet image receiving sheet HR-101S manufactured by Canon Inc. so that the adhesive layer in the thermally transferable image protective sheet faced the image receiving surface in the ink jet image receiving sheet. The assembly was heated by means of a laminator Lamipacker LPD 3204 manufactured by Fujipla Inc. under conditions of heat temperature 130° C. and speed 5 mm/sec. In this state, the samples were measured for peel force under the following conditions.

<Peel Force>

After the assembly of each of the thermally transferable image protective sheet and the image receiving sheet was heated under the above conditions, a 180-degree peel test was carried out according to JIS K 6854 with a surface property measuring apparatus HEIDON-14 manufactured by Shinto Scientific Company Ltd. to measure the peel force. The results are shown in Table 2.

The results of the measurement of peel force were evaluated according to the following criteria.

◯: The peel force was less than 100 gf/25 mm which was practically suitable. No separation occurred during handling until setting of the sample in the measuring apparatus.

Δ: The peel force was not less than 100 gf/25 mm and less than 5000 gf/25 mm, that is, was not practically suitable.

X: The peel force was not less than 5000 gf/25 mm, and a difficulty was encountered in separation.

The thermally transferable image protective sheets and the image receiving sheet were provided and heated under the above conditions. The support was then separated to prepare prints with a protective layer formed thereon. For these prints, the specular glossiness at 60 degrees of the surface of the protective layer according to JIS Z 8741 and the surface roughness of the protective layer were measured.

<Specular Glossiness>

The specular glossiness at 60 degrees of the surface of the support on its peel layer side and the surface of the protective layer after transfer was measured according to JIS Z 8741 with a gloss meter VG-1001 DP manufactured by Nippon Denshoku Co., Ltd.

<Glaringness>

The samples after transfer were put on a wall, and the glaringness of the image was visually evaluated under a fluorescent lamp in a room.

◯: There was no glaringness even when the image was viewed from every angle, and the contents of the image could be confirmed.

Δ: Although there was no glaringness when the viewing angle was between normal to the transfer face of the sample and 75 degrees, glaringness occurred on such a level that made it impossible to confirm a part of image contents when the viewing angle was between 75 degrees and 90 degrees.

X: Although there was no glaringness when the viewing angle was between normal to the transfer face of the sample and 30 degrees, glaringness occurred on such a level that made it impossible to confirm a part of image contents when the viewing angle was between 30 degrees and 90 degrees.

The specular glossiness of the surface of the support on its peel layer side is shown in Table 1, and the specular glossiness and visual glaringness of the surface of the protective layer after the transfer are shown in Table 2.

<Surface Roughness>

The surface roughness Ra of the support on its peel layer side and the surface roughness Ra of the protective layer after the transfer were measured with a surface roughness tester Surfcom 1400 D-3DF-12 manufactured by Tokyo Seimitsu Co., Ltd.

The results of measurement of the surface roughness Ra of the supports on their peel layer side are shown in Table 1, and the results of measurement of the surface roughness Ra of the protective layer after the transfer are shown in Table 2.

TABLE 2

| | Specular glossiness | | | |
|---|---|---|---|---|
| | of surface of | | | |
| | protective layer | Surface | | |
| | after transfer | roughness Ra of | | |
| | as measured | protective layer | Peel | Visual |
| | at 60 degrees | after transfer | force | glaringness |
| Ex. 1 | 22.6% | 0.334 | ∘ | ∘ |
| Ex. 2 | 59.4% | 0.288 | ∘ | Δ |
| Ex. 3 | 7.5% | 0.371 | Δ | ∘ |
| Comp. | 96.6% | 0.115 | ∘ | x |
| Ex. 1 | | | | |

As is apparent from the foregoing description, the thermally transferable image protective sheet of the present invention comprises a thermally transferable resin layer having a single-layer or multilayer structure stacked on a support so as to be separable from the surface of the support. In use, the thermally transferable resin layer is thermally transferred on an image in a print so as to cover at least the printed portion in the print followed by the separation of the support. In this case, the specular glossiness of the surface of the thermally transferable resin layer after transfer in the print is less than 65% as measured at 60 degrees according to JIS Z 8741, or the surface roughness Ra of the thermally transferable resin layer after transfer in the print is not less than 0.130, or the specular glossiness of the surface of the support on its thermally transferable resin layer side is less than 65% as measured at 60 degrees according to JIS Z 8741, or the surface roughness Ra of the support on its thermally transferable resin layer side is not less than 0.100. By virtue of the above construction, in a print (a record) covered with the thermally transferable resin layer after transfer from the thermally transferable image protective sheet, the image is protected, possesses excellent fastness or resistance properties such as excellent lightfastness, and, in the case of records for outdoor applications or the like, is free from dazzle caused by the reflection of light at the time of viewing of the image.

1. A thermally transferable image protective sheet comprising: a support; and a thermally transferable resin layer having a single-layer or multilayer structure stacked on the support so as to be separable from the surface of the support, the thermally transferable image protective sheet having been constructed so that the thermally transferable resin layer is thermally transferred on an image in a print so as to cover at least the printed portion in the print followed by the separation of the support and the specular glossiness of the surface of the thermally transferable resin layer after transfer in the print is regulatable to less than 65% as measured at 60 degrees according to JIS Z 8741.

2. A thermally transferable image protective sheet comprising: a support; and a thermally transferable resin layer having a single-layer or multilayer structure stacked on the support so as to be separable from the surface of the support, the thermally transferable image protective sheet having been constructed so that the thermally transferable resin layer has been thermally transferred on an image in a print so as to cover at least the printed portion in the print followed by the separation of the support and the surface roughness Ra of the thermally transferable resin layer after transfer in the print is regulatable to not less than 0.130.

3. A thermally transferable image protective sheet comprising: a support; and a thermally transferable resin layer having a single-layer or multilayer structure stacked on the support so as to be separable from the surface of the support, the thermally transferable image protective sheet having been constructed so that the thermally transferable resin layer is thermally transferred on an image in a print so as to cover at least the printed portion in the print followed by the separation of the support and the specular glossiness of the surface of the support on its thermally transferable resin layer side is less than 65% as measured at 60 degrees according to JIS Z 8741.

4. A thermally transferable image protective sheet comprising: a support; and a thermally transferable resin layer having a single-layer or multilayer structure stacked on the support so as to be separable from the surface of the support, the thermally transferable image protective sheet having been constructed so that the thermally transferable resin layer is thermally transferred on an image in a print so as to cover at least the printed portion in the print followed by the separation of the support and the surface roughness Ra of the support on its thermally transferable resin layer side is not less than 0.100.

5. The thermally transferable image protective sheet according to any one of claims 1 to 4, wherein a filler has been incorporated in the support to roughen the surface of the support on its image protective layer side.

6. The thermally transferable image protective sheet according to any one of claims 1 to 5, wherein the image in the print has been formed by an electrophotographic recording method, an ink jet recording method, or a thermal transfer recording method.

7. A method for protective layer formation, comprising the steps of:
providing the thermally transferable image protective sheet according to any one of claims 1 to 6 and a print;
putting the thermally transferable image protective sheet and the print on top of each other so that the thermally transferable resin layer is brought into contact with the image face of the print, and thermally transferring the thermally transferable resin layer onto the image in the print so as to cover at least the printed portion in the print; and
then separating the support to form a protective layer on the image in the print.

8. A record comprising a protective layer provided on an image in a print, said protective layer having been provided by thermally transferring a thermally transferable resin layer by the method for protective layer formation according to claim 7.
